(19) United States
(12) Patent Application Publication
(10) Pub. No.: US 2004/0120854 A1
(43) Pub. Date: Jun. 24, 2004

(54) Silicon-wafer based devices and methods for analyzing biological material

(76) Inventors: James R Heath, Los Angeles, CA (US); Rigo Pantoja, Los Angeles, CA (US); Francisco Bezanilla, Los Angeles, CA (US); Daniel M Sigg, Los Angeles, CA (US)

Correspondence Address: David J Oldenkamp, Shapiro & Dupont, Suite 700, 233 Wilshire Boulevard, Santa Monica, CA, 90401, US

(21) Appl. No.: 10/473,784

(22) PCT Filed: Apr. 4, 2002
(86) PCT No.: PCT/US02/10673

(51) Int. Cl. G01N 31/22

(52) U.S. Cl. 422/57

(57) ABSTRACT

A semi-conductor wafer-based device that is used to suspend biological materials, such as lipid bilayers or single cells, for chemical, electrical and/or optical examination. The wafer has a t least one pore that extends therethrough. The pore is of sufficient size to suspend a lipid bilayer or a cell therein. The surface of the pore is coated with an insulating film to provide an insulating surface to which the lipid bilayer/cell is attached when the lipid bilayer/cell is suspended within the pore. The divice is used to measure the physical properties (e.g., voltage gating) of cells and lipid bilayers that contain biomolecules such as transmembrane proteins.

### BACKGROUND OF THE INVENTION

1. Field of the Invention

The present invention relates generally to biomolecular devices that can be utilized for pharmaceutical screening in highly controlled and yet physiological conditions. It specifically relates to biomolecular devices that can be coupled with electrical, optical, and/or chemical probes for interrogating the response of various cells and biological compounds to chemical, optical, or electrical stimuli. More specifically, the present invention relates to improved devices and the methods for making such devices wherein the fabrication tools used to make such devices are derived from silicon and other semiconductor processing steps.

2. Description of Related Art

The publications and other reference materials referred to herein to describe the background of the invention and to provide additional detail regarding its practice are hereby incorporated by reference. For convenience, the reference materials are cited by author and date and referenced in the appended bibliography.

Patch clamp experiments provide a powerful approach for interrogating the biophysical properties of membrane proteins. In a patch clamp experiment, a glass micropipette, containing a microelectrode and having an orifice of 1-2 micrometers in diameter, is brought into contact with a cell, and suction is applied to pull the cell into contact with the pipet (Neher, 1976; Sakmann, 1995; Fertig, 2001). The electrophysiological properties of the membrane proteins are then probed by measuring the current voltage response across the cell membrane. High quality seals between the membrane and the pipet are required, and the standard accepted figure of merit is a gigaohm resistance across the membrane. When such a seal is formed, the cell, or membrane, is said to be patched. Such a technique, and its related variations, allows for the interrogation of single cells and model membrane systems, and it has proven to be a useful tool for probing the biophysics of lipid bilayers and transmembrane proteins. The approach does have certain limitations. For example, optical and chemical access to the patched membrane is very difficult due to the restrictive geometric characteristics of the microelectrode. In addition, the micropipette-based approach is serial by its very nature, and it would be desireable to carry out multiple measurements in parallel. As a final limitation, the micropipette-based approach is limited to the investigation of membrane proteins incorporated into the naturally occurring bilayers that are characteristic of living cells. It is often desireable to investigate such proteins when they are incorporated into model bilayers, so as to more fully understand the membrane/protein interactions.

Thus, variations on the microelectrode/micropipette approach have been developed. One set of techniques involves the formation of supported bilayers on mica, glass, and Si/SiO₂ substrates, and these systems have proven useful for studies of both active and non-active membrane proteins using various optical and scanning probe microscopies (Sackmann, 1996). There are two specific techniques that have proven useful in preparing bilayers with reconsitituted membrane proteins for optical studies. In the first one, a Langmuir-Blodgett (LB) monolayer is transferred to the substrate, followed by the deposition of a vesicle with incorporated proteins (Kalb et al., 1992). The vesicle spreads so that the lipids from the vesicle form the top bilayer leaflet. The second method also involves direct deposition of vesicles containing membrane protein directly onto a hydrophilic surface. In this instance, the vesicles spread and form bilayers on the substrate (Brian and McConnell, 1984; Cremer, 1999). These two techniques have provided much insight to our understanding of lipid diffusion (Kalb et al., 1992; Groves et al., 1997; Harms et al., 1999) and rotation (Harms et al., 1999). The orientation (Tatulian et al., 1995; Salafsky et al., 1996) and functional (Salafsky et al., 1996) properties of reconstituted transmembrane proteins have also been reported. Tamm and co-workers have also recently reported on a method which increases the distance between the bilayer and the substrate by first depositing a LB film of a cushion polymer (Wagner, 2000; Hann, 2000) followed by LB monolayer deposition and then direct deposition of vesicles with incorporated protein. This development minimizes the interaction of transmembrane proteins to the substrate and, in effect, allows the proteins to carry out their activity as they do in a natural cell environment.

However, these supported bilayer techniques also have their shortcomings. It is difficult to electrically isolate a region of the bilayer using one of the above described techniques in order to monitor ionic currents from a single ion channel. Isolating a region of a bilayer requires that a high resistance (gigaohm) seal be formed between the bilayer and the supporting structure. Furthermore, since there is only about a 10-50 Å water film separating the bilayer from the substrate, solution exchange within this region is not feasible. To the best of our knowledge, no reports of voltage clamping of these types of supported bilayers have appeared in the literature. In addition, the very nature of a supported bilayer technique makes it a method for studying model systems, such as a system containing a particular kind of protein in a model bilayer, but in the absence of the cellular complexity that characterizes a natural system. It is not possible to investigate active cells using supported bilayer techniques.

A second set of alternative approaches has been to utilize suspended, or ‘painted’ bilayers into which isolated transmembrane proteins may be reconstituted. Bilayers are painted onto micropores that are punched through Teflon or plastic sheets, and the presence of a bilayer is determined by measurement of the characteristic bilayer capacitance (Wonderlin et al., 1990; White, 1986). These approaches, in many ways, lead to artificial systems for studying the intrinsic kinetic, structural and pore selectivity properties of ion channels in a chemically isolated environment. Such a model system, while desireable in many cases, is again in contrast to the standard micropipette patch-clamp method used for probing single-ion channels in a natural, living cell. In such an environment, other biomolecules may contribute to the patch clamp measurement, and solution exchange within the micropipette is difficult. For the painted-bilayer model systems, separate solution phase chemical access to either side of the membrane is straightforward, and this is an advantage over the supported bilayer approaches.

Plastic micropores, in contrast to TEFLON micropores, have proven excellent in reducing the access resistance, due to their intrinsic thin rim apertures. A stable horizontal bilayer orientation has also been demonstrated for the plastic partitions (Wonderlin et al., 1990), and such an orientation is desirable for optical experiments.

The preparation of plastic partitions for the preparation of suspended bilayers is, however, phenomenological, with results that fluctuate from preparation to preparation. It is also difficult to control the bilayer/solid interfacial properties in these types of partitions because the surface chemistry of TEFLON or plastic is typically not subject to chemical modification. Plastic partitions are also not appropriate for investigating single cells, but are more appropriate for investigating model bilayer/protein systems. Also, the use of plastic as a substrate effectively rules out the possibility of building electrodes, optical probes, or fluidic channels onto the substrate. Such options are critical if one is going to have an on-chip laboratory for investigating the properties of membrane proteins in a physiological environment. In addition, such options are also critical if one is going to develop a combinatorial approach that interrogates the action of pharmaceuticals and other molecular species on membrane proteins by carrying out multiple experiments on different protein/bilayer systems simultaneously and on a single platform.

Definitions

Large Pore Devices in this context refers to semiconductor chips in which a pore, or hole, has been micromachined through the wafer, and that pore has a diameter of 50 to 200 micrometers.

Small Pore Devices in this context refer to semiconductor chips in which a pore, or hole, has been micromachined through the wafer, and that pore has a diameter of 1-2 micrometers.

Giga-seal in this context refers to the electrical characteristics of a cell or membrane interface with the surface surrounding a pore micromachined into a wafer. The resistance across the cell membrane, or of a bilayer membrane that spans the pore is 1 gigaohm (10⁹ Ohms) or greater. Such a measurement implies a high quality seal.

Patched, in this context, refers to a cell or a membrane that is sealed across a pore or a micropipette tip. A high quality patch is one that is also a giga-seal.

Cell-attached mode in this context refers to a device in which a single cell is sealed to the pore with a seal resistance of a gigaohm or greater.

Whole-cell mode in this context refers to a device in which a single cell was sealed to a pore with an electrical resistance of the seal of a gigaohm or greater. A small amount of pressure is applied across the chip/cell interface so that the cellular membrane that spans that interface ruptures. Electrophysiology measurements then interrogate the capacitance and current voltage properties of the entire cell, except for the small component that was ruptured.

Cis-side, in this context, refers to the side of a model bilayer to which a vesicle containing membrane proteins is fused. This is typically the top side of a bilayer, in laboratory orientation.

Trans-side, in this context, refers to the side of a model bilayer that is opposite to the side to which a vesicle containing membrane proteins is fused.

Exterior-side, in this context, refers to the region outside of a cell, and the chemical environment of that region.

Interior-side, in this context, refers to the region that is open to the interior of a cell, or that is in contact with the patched membrane of a cell. For example, in a whole-cell mode experiment, a cell is supported on a pore or a micropipette tip, and the membrane spanning the pore or the tip is ruptured. Then the side of the pore or the micropipette tip that is open to the ruptured portion of the cell is the interior-side.

Biological materials, as used herein, includes cells and cell membranes, lipids and lipid bilayers, as well as any other material of biological interest.

### SUMMARY OF THE INVENTION

In accordance with the present invention, semi-conductor wafer-based devices are provided that can be used for a range of experimental measurements, ranging from investigating a suspended lipid bilayer containing a single membrane protein, to a single cell containing many different membrane proteins. For this entire range of systems, chemical and electrical access to the cis or trans sides of the bilayer, or to the interior or exterior environments of a cell, is possible. The geometric nature of the device also allows for simultaneous optical interrogation of the suspended bilayer (Pantoja, 2001) or the single cell as the electrical membrane potential or the chemical environment surrounding the membrane or cell is varied. The wafer has at least one pore that extends through the entire thickness of the wafer, and the diameter of that pore may be customized to allow for the probing of single proteins reconstituted in model suspended bilayers (large pores with diameters in the range of 50-200 micrometers), or to allow for the probing of membrane proteins within a physiologically active cell (small pores with diameters in the range of 1-2 micrometers). The surface of the pore is coated with an insulating film to provide an insulating surface to which the lipid bilayer is attached when the lipid bilayer is suspended within the pore, and the surface of the pore may be chemically treated to customize the surface of the chip for promoting the adhesion of the bilayer or the cell. The height of the pore is small (less than 100 micrometers) to allow for solution exchange through the pore to the patched membrane or cell. The devices are suitable for use in measuring the physical properties (e.g., voltage gating) of lipid bilayers and single cells that contain biomolecules such as transmembrane proteins.

This invention describes a single set of fabrication techniques for preparing both model, suspended membrane systems and single-cell based devices for electrophysiology measurements, with separate chemical, electrical, and optical access to either side of the suspended membrane or cell. The invention describes the use of a silicon wafer as the support substrate for all devices. Similar fabrication techniques (optical lithography followed by deep reactive ion etching processes) are utilized to micromachine pores through the wafers for both types of devices, and the membranes and cells are suspended across these pores. The pore size that is fabricated depends upon the nature of the application: suspended membranes require larger pores than single cells. For all devices, components of fluidics chambers are also micromachined onto the wafer, and the wafer is thinned in the region of the pore to enable fluid flow through the pore, and thus to allow for the solution chemical exchange through the pore. The partial fluidics chambers are coupled with partitions mounted onto the wafer to enable a separate control over the chemical composition of the solution surrounding the front and back side of the membrane. A SiO₂ insulating layer is grown over the silicon wafer to achieve electrical isolation of the front and back sides of the wafer from each other. The choice of silicon as the supporting wafer enables co-fabrication of electronics (voltage sources, electrodes, amplifiers) on the same wafer platform, and also enables the preparation of many devices on a single wafer for combinatorial measurement approaches. The choice of an SiO₂ insulating layer also enables the custom chemical modification of the wafer surface to promote adhesion of either the membranes or the single cells. High quality electrical seals (gigaohm resistive seals) are demonstrated for both the membrane and the single cell devices. The incorporation of membrane proteins into the model membranes is demonstrated, and the patching of single cells containing similar membrane proteins is also demonstrated. Electrophysiology measurements on these devices yield results that are consistent with the literature reported behavior of these membranes and cells. The devices are suitable for pharmaceutical screening and for chemical and biochemical sensing.

The above described and many other features and attendant advantages of the present invention will become better understood by reference to the following detailed description when taken in conjunction with the accompanying drawings.

### BRIEF DESCRIPTION OF THE DRAWINGS

FIG. 1 is a top view of a bilayer (10) suspended over a large pore of a silicon microchip (11). The illumination is from a lamp above and the image collection is from below the wafer. The triangle in the bottom center (12) is a digital artifact.

FIG. 2 is a top view optical micrograph of a CHO cell (20) sealed to a small pore (21) of a silicon microchip.

FIG. 3 is a cross-sectional view of the steps required to fabricate an exemplary device in accordance with the present invention.

FIG. 4 is a cross-sectional drawing of a large-pore device (40) with a bilayer (41) patched. The surface of the wafer has been chemically treated (36) to promote adhesion of the bilayer. Chambers (42,43) have been sealed to the top (cis) and bottom (trans) sides of the wafer, and have been filled with electrolyte solutions (44,45) of differing compositions. Electrodes (not shown) are immersed into the cis (42) and trans (43) chambers for recording the electrophysiological activity of a protein incorporated into the bilayer membrane (41). This device allows for chemical, optical and electrical access to both the cis and trans sides of the membrane bilayer (41). The silicon wafer has been micromachined to allow for optical access to the suspended membrane (41) with an illumination that is at an angle of up to 45 degrees from normal incidence.

FIG. 5 is a series cross-sectional drawing of a device (50) fabricated with a small pore (34) illustrating how a single cell (53) may be assembled for investigation of its optical, electrical, and chemical properties. The surface of the wafer (52) has been chemically treated with a thick, hydrophilic electrical insulating layer to both electrically isolate both sides of the wafer, and to promote adhesion of the cell (53) to the pore (51). Chambers (54,55) have been sealed to the top (exterior) and bottom (interior) sides of the wafer, and have been filled with electrolyte solutions (56,57) of differing chemical compositions. Electrodes are immersed into the exterior (54) and interior (55) chambers for recording the electrophysiological activity of the cell (53). Cells (53) are added to the exterior solution (56) and gentle suction is applied to bring the cell to the pore (51) and to create a high quality, electrically resistive giga-seal (58) for a device operating in cell-attached mode. Gentle suction can again be applied to rupture the portion of the cell membrane spanning the pore (59), and to open the interior of the cell up to the interior chamber (57), to modify the device so that it is operating in whole cell mode. This device allows for chemical, optical and electrical access to both the exterior and interior sides of the cell (53).

FIG. 6. depicts recordings of an active Maxi K-type ion channel protein reconstituted in a bilayer suspended within the pore of silicon microchip fabricated in accordance with the present invention. The arrows indicate no ionic current is going thru the ion channel because it is in the closed state. The half-activation potential is estimated to be equal to −69.4 mV with a charge of −0.81. The open probability (Po) does approach unity at high membrane potential (Vh) because [Ca²⁺]=0.1 mM, which is a high.

FIG. 7. is a graph where the open probability(Po) versus the membrane potential(Vh) is plotted for a Maxi-K-type ion channel reconsistituted in a bilayer and suspended across a pore that was micromachined into a silicon wafer in accordance with the present invention.

FIG. 8. is a series of current-voltage experimental measurements that correlate with the process of patching a CHO cell on a small pore device. Initially the pore is open (80) and the cell is not sealed to the pore, and the resistance of the pore is the access resistance. Application of a gentle suction brings the cell to the surface of the pore (81) and the current magnitude drops significantly. Application of an additional amount of suction results in a patched cell in which the patch is a giga-seal (82), and the device configuration corresponds to cell-attached mode. The further application of gentle pressure ruptures the cell membrane spanning the pore (83), leading to a whole-cell mode type measurement that is characterized by a larger magnitude current response to an applied voltage and is the cell-attached configuration.

FIG. 9. reveals the current-voltage behavior of RIN m5F cells containing maxi K_{Ca} channels as measured in cell-attached mode (90) and whole-cell mode (91). The saturation behavior observed in whole-cell mode is characteristic of the maxi K_{Ca} ion channel proteins.

### DETAILED DESCRIPTION OF THE INVENTION

In accordance with the present invention, horizontally oriented devices capable of supporting single cells or suspended bilayers, and with electrical and chemical access to the interior and exterior of the cell, or to either sides of the bilayer, were obtained by using a microfabricated silicon partition. Reconstituted type Maxi K⁺ ion channels in painted bilayers, and CHO and RIN m5F cells, served as model systems for electrophysiological investigations of membrane proteins. Chemical treatment of the wafer surface promoted adhesion of the cells or the membrane, and was customized for those two separate cases. Silanization of the SiO₂ surface produced a hydrophobic surface that promoted the adhesion of painted phospholipid bilayers. By contrast, acid cleaning of the SiO₂ surface produced a hydrophilic surface that promoted adhesion of single cells. Standard lithographic techniques and anisotropic deep-reactive ion etching were used to micromachine exemplary large pores with diameters from 50 to 200 micrometers, and exemplary small pores from 1 to 2 micrometers.

For the large pore devices, the cylindrical structure of the pores in the partition, coupled with the surface treatment resulted in extremely robust bilayers, which remained unchanged after reconstitution of Maxi K⁺ ion channel proteins. The measured capacitance of the bilayers suspended on the microchips also demonstrated that the intrinsic noise amplitude of the system scaled with bilayer area. The 100 μm and 200 μm diameter pores produced 0.5 pA and 1.9 pA rms noise amplitudes respectively with active ion channels. The intrinsic access resistance of the microchip was less than 50KΩ. Therefore, the microchip bilayer suspension devices and methods in accordance with the present invention provide an excellent alternative system for studying reconstituted membrane proteins with optical and electrical probes, and provides a route toward preparing in situ transmembrane protein libraries for pharmaceutical testing. The suspended lipid bilayers are characterized by a high resistance (gigaohm or better) seal to the semiconductor wafer, and electrical and chemical access to both sides of the bilayer is enabled. Optical access to the bilayer is also enabled.

For the small pore devices, the geometry of the devices, coupled with the hydrophilic nature of the wafer surface, led to extremely robust single cell devices that exhibited excellent performance for at least two types of cells. The intrinsic access resistance of the microchip was between 2 and 7 megaohms for pore diameters in the range of 1.5-2 micrometers. When CHO or RIN m5F cells were patched to these pores, excellent, electrically insulating seals were formed with cell/pore seal resistances on the order of 1 to 5 gigaohms. When the intact cell sealed to the pore cell-attached mode, characteristic electrophysiology measurements could be carried out. Application of gentle pressure across the cell/pore interface led to rupture of the cell membrane that spanned the pore, and enabled measurements of the electrophysiology characteristics of single cells in the configuration known as ‘whole-cell’ mode. For the RIN m5F cells, the electrophysiological activity of naturally occurring maxi K_{Ca} ion channels was recorded from those cells, and characteristic current-voltage saturation behavior was recorded. Electrical and chemical access to both the inside and outside of the cell is enabled, and optical access to the cell is also enabled.

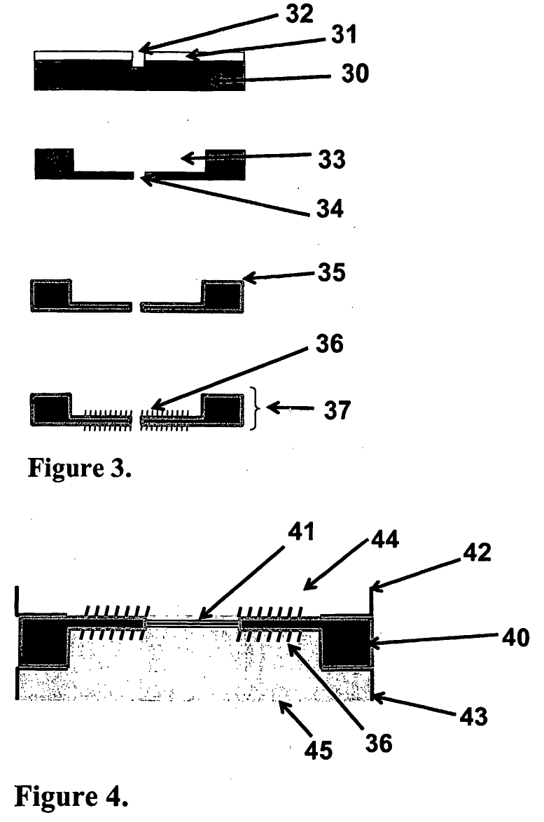

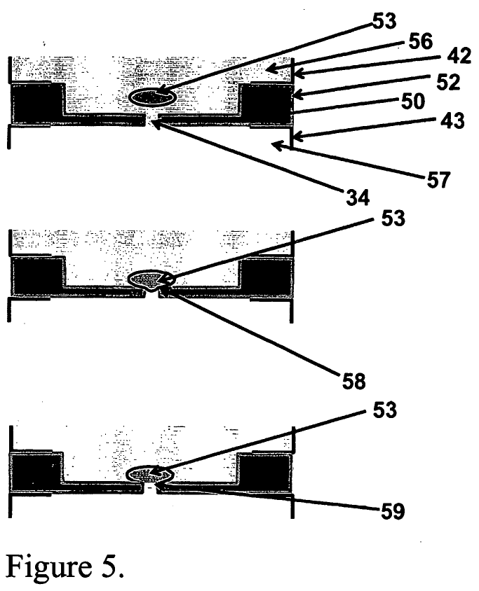

In accordance with the present invention, a similar set of devices and methods are provided for preparing suspended membrane systems or a suspended cell on micromachined silicon wafers. A similar set of microfabrication steps are employed for both the suspended membrane devices and the single cell devices, with the major difference being that membranes are suspended over large pores, while the cells are suspended over small pores. Referring to FIG. 3, a silicon wafer (30) is coated with photoresist (31) and a hole (32) is defined using optical lithography and micromachined into the wafer using an etching process. For devices designed to interrogate proteins in suspended membrane structures, the hole (32) is a large pore of diameter 50-200 micrometers. For devices designed to interrogate single cells, the hole (32) is a small pore of diameter 1-2 micrometers. The wafer (30) is then turned over, and a larger chamber (33), centered over the hole (32), is micromachined through a silicon wafer using optical lithography to define the location of the chamber and etching process to develop the chamber. The chamber is etched to a depth so that the hole becomes a continuous pore (34) through the wafer, breaking through the wafer surface in the center of the chamber area (33). An insulating layer (35) is then grown over the entire wafer so that the front and rear surfaces of the wafer are electrically isolated from one another. The chemical nature of the wafer surface may be customized for promoting the adhesion of either the bilayers or the cells. This insulating layer may then be silanized (36) or otherwise chemically treated, such as acid cleaned, to prepare hydrophobic or hydrophilic surfaces, respectively. Such treatments render the surface of the wafer to be favorable for promoting adhesion of a membrane bilayer (hydrophobic surface) or a cell (hydrophilic surface). As shown in FIGS. 4 and 5, chambers are added to the top (42) and bottom (43) regions surrounding the pore to allow for the introduction of solutions (44,45,56,57) containing electrolytes, ligating agents, etc.

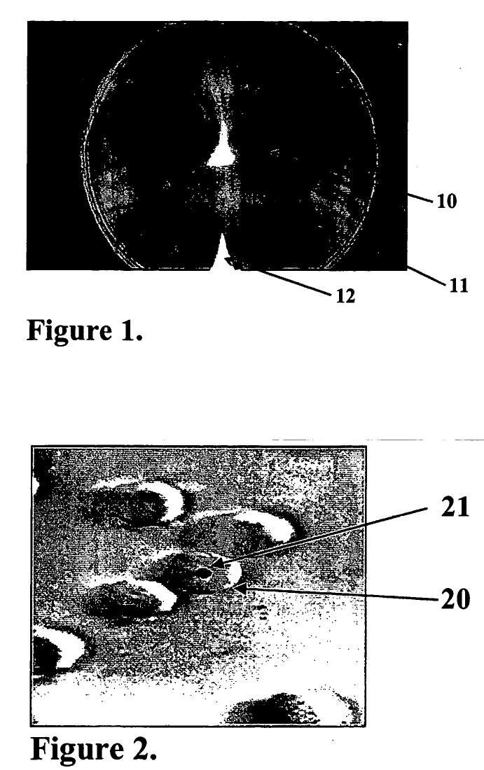

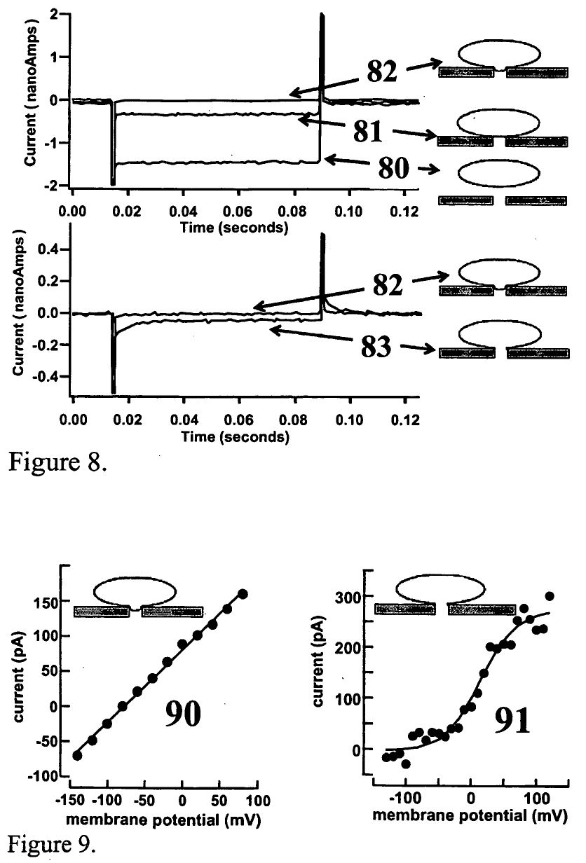

For the suspended bilayer (large pore) devices (40) as shown in FIG. 4, we further demonstrate that single ion channels can be incorporated into the bilayers (41), and so these devices provide a framework for investigating model membrane/protein interactions. The ion channel proteins can be voltage clamped, and optical and chemical access to the bilayers is readily achieved. For example, see the optical image of a bilayer shown at 10 in FIG. 1. For the single cell (small pore) devices (50), we demonstrate that giga-seal patches are readily achieved between the cells and the pores (80,81,82) that the electrical activity of membrane proteins can be monitored in both cell-attached (90) and whole-cell modes (91) (see FIGS. 8 and 9). The cells can be voltage clamped, and separate optical (20,21) and chemical access to the external (56) and internal (57) regions of the devices is readily achieved (see FIGS. 2 and 5, respectively). Much of the variability in conditions associated with micropipets, or with the plastic and TEFLON partitions discussed in the Background of the Invention is removed by utilizing lithographic and etching techniques to control the pore size, and by using silanization (36) and other chemical treatment techniques to control the membrane/pore chemical interface. Finally, the silicon processing is a very advanced art, and it is relatively straightforward to design combinatorial architectures for probing membrane proteins in physiological environments based on the present invention. For example, fluidics and microfluidics devices, microelectrodes, and even lasers and other photonic devices may be fabricated on the same chip that contains an array of membrane- or cell-supporting pores. Thus, a combinatorial ‘lab-on-a-chip’ can be readily designed to interrogate the action of pharmaceuticals and other molecular probes on transmembrane proteins.

Schmidt and coworkers (Schmidt et al., 2000) have recently reported on a microchip based technique in which electrophoretic focusing is utilized to trap a vesicle at a pore micromachined through a SiN₃ diaphragm. That work, while bearing some similarities to what is reported here, is substantially different with respect to device architecture, membrane preparation, and the issues of chemical, electrical, and optical access to either side of the bilayer, and is not obviously extendable toward the investigations of single cells.

Advances in silicon processing techniques, coupled with progress in the organic chemistry of SiO₂ surfaces, have enabled the coupling of silicon micromachined devices with biological materials (Jaklevic et al., 1999; Voldman et al., 1991). The flexibility of silicon fabrication techniques has made silicon the ideal substrate for constructing a microlaboratory for interrogating everything from cell populations to macromolecular libraries. Here we extend this concept by suspending lipid bilayers and single cells into pores etched in silicon wafers. In the following detailed description of the invention, we first present the technical details of the microfabrication processes, and we then describe the preparation of the ion channel proteins and cell lines that we have utilized as a demonstration of this invention. The suspended bilayer devices are discussed in terms of the optical and capacitance characteristics of suspended bilayers using four different pore diameters in the range from 50 to 200 μm. The suspended cell devices are discussed in terms of the optical and capacitance measurements of CHO cells interrogated in cell-attached and whole-cell modes. Finally, we present voltage gating measurements, temporal stability, and noise characteristics of single ion channel proteins and single RIN m5F cells incorporated into these exemplary devices.

One of the major differences between the previously described work using TEFLON/plastic partitions and micropipettes, and the silicon wafers of the present invention lie in the versatility of silicon processing, as well as the rich surface chemistry of SiO₂. First, a similar set of fabrication approaches may be utilized for both investigating single proteins in model membrane systems, and for investigating membrane proteins in single cells. The variations between the suspended membrane devices and the single cell devices are the surface chemical treatment of the microfabricated chip, and the pore size that is microfabricated into the chip. Both large pores and small pores may be defined using standard optical lithography techniques. These silicon wafer devices may be custom-designed to enable optical experiments, and the bilayers and cells reported here exhibit excellent stability when they are horizontally mounted. Second, the pore diameter and thickness, as well as the organic silanization or other chemical treatment of the wafer surface, are all experimental variables that can be separately optimized to minimize membrane capacitance and electrical noise, while maximizing the temporal stability of incorporated ion channels and cells.

Examples of practice are as follows:

The following examples describe the preparation and use of devices in accordance with the present invention.

Preparation of Large Pore Devices (FIG. 4) Large pores (34) with diameters ranging from 50 to 200 microns (μms) were micro-machined in silicon wafers (30) using well-established semiconductor processing techniques. Phosphorous doped, 1 cm diameter×280-320 μm thick, 111 crystal orientation, N-type wafers were purchased from WaferNet (San Jose, Calif.). The wafers were thinned to about 200 μm thickness with a deep reactive ion etcher (DRIE) using the Bosch 59 process. This step reduced the amount of time required to etch the pores through the wafer, since the etch rate decreases with diminishing feature size. Next, the wafers were cleaned by ultrasonication in acetone for 5 minutes and then in 2-propanol for 5 minutes, and immediately rinsed thoroughly with deionized (DI) water (18 MΩ) and air dried under flowing N₂. Then, a dehydration bake was done by placing the wafer on a 150° C. hot plate for at least 5 minutes, and the wafer was cooled to room temperature.

Negative photo-resist (NPR) and SU-8 developer were both purchased from MicroChem Corporation (Newton, Mass.) (Loechel et al., 2000). NPR, which produces a thick (15-20 μm) and robust etch-resistant plastic film, was spun onto the wafer using a programmable Headway Research spin coater. This was followed by a pre-exposure bake at 95° C. for 15 minutes. A 2-minute lithographic exposure (350 W mercury arc lamp; 365 nm) was carried out using a Karl Suss mask aligner. Next, a post-exposure bake was done at 95° C. for 30 min, and the wafer was cooled to room temperature.

The wafer was then placed in SU-8 developer also for about 3 to 4 minutes, and rinsed with DI water and dried under flowing N₂. The wafer was then glued onto a carrier wafer (bottom side) using a few drops of AZ5214 photo-resist from Clariant Corporation (Sunnyvale, Calif.). This step was done in order to maintain a constant base pressure during the etching process. The bonded-pair of wafers was then placed in a PlasmaTherm SLR770 ICP DRIE in which the patterned wafer with photo-resist was exposed to a cycle of SF₆ and C₄F₈ plasmas, resulting in a deep anisotropic etch, at an etch rate of about 2.5 μm/min. The wafers were then separated from each other by dissolving the AZ5214 with acetone.

The SU8-5 photoresist was removed by first immersing the wafer in an oxidizing solution (2:1 concentrated H₂SO₄:H₂O₂(30%)) for about 15 minutes, and then immersing it in an identical but fresh solution of the same mixture for 30 minutes. Finally, the wafer was rinsed with DI water and then dried under flowing N₂. The wafer was diced into chips (4 mm×4 mm) resulting in one pore per chip. Finally, an oxide coating (SiO₂) was applied to both sides of the chip using a PlasmaTherm 790 Series plasma enhanced chemical vapor deposition (PECVD) device. The deposition time was 20 minutes, which produces an oxide thickness of about 1 μm.

Large Pore Device Microchip surface treatment A hydrophobic surface on the partition was necessary to promote surface wetting by the n-decane solvent used to dissolve the phospholipid mixture. Therefore, a silanization step was done just prior to painting the pore with the phospholipid bilayer. If more than a day elapsed between the silanization and application of the bilayer steps, the chips were cleaned by ultrasonication in an acetone solution for 5 minutes and then in 2-propanol for another 5 minutes, and immediately rinsed thoroughly with DI water (18 MΩ) and air dried under flowing N₂, prior to silanization. The silanization was done by placing the chips vertically on an aluminum foil base in a 300 mL Pyrex jar and depositing 100 μliters of tri-n-butylchlorosilane from Pfaltz and Bauer (Waterbury, Conn.) on the jar bottom. The jar was immediately capped with a Pyrex cap and sealed with Teflon tape. The vessel was then placed in an oven at 160° C. for 24 hours.

Preparation of Small Pore Devices (FIG. 5) The small pore devices were prepared in a manner that was very similar to how the large pore devices were prepared. The essence of both the large-pore and small-pore devices was that they both utilized standard optical lithography techniques to define the pore and other features on a silicon wafer, and deep reactive ion etching was utilized to develop those patterns. Phosphorous doped, 2 inch diameter×200 mm thick <100> silicon wafers were purchased from Virginia Semiconductor (Fredericksburg, Va.). A positive photoresist (STR1045, MicroChem Corporation, Newton Mass.) was utilized in concert with a custom-designed mask (Photo-Sciences) and a Karl Suss MA6 mask aligner (Karl Suss, Munich, Germany), operating with constant intensity lines at 365 nm and 405 nm and in constant power mode at 8 mW/cm². The patterns were developed using a PlasmaTherm SLR770 ICPdeep reactive ion-etching system (Unaxis Corporation, St. Petersburg, Fla.). Each wafer was fabricated with a 2×2 array of usable pores, or four devices per array. However, only one of the devices was used for any given experiment, and so the chips were diced into four 8 mm×8 mm sections, each containing a single device. The chips were acid cleaned, washed using copious amounts of 18MΩ H₂O, and and dried under flowing N₂. The chips were then oxidized with a PlasmaTherm PECVD 790 Series (Unaxis, Corp.). This procedure serves a dual purpose since it not only provided a layer of insulation but also shrinks the pore diameters from 1.9 μm to about 1.5 μm. The chips were then immersed into a hot H₂SO₄/H₂O₂/H₂O (40/40/20) solution for 1 hour, and then rinsed with excess quantities of 18MΩ H₂O. This last treatment makes the SiO₂ surface hydrophilic and increases the quality of the seal between the cell and the pore. At this point, the chip fabrication is essentially complete, and the device is fully assembled by sealing PDMS-based chambers (42,43) onto the front and back sides of the chip surface. This was done by coating the chips with SU-8-5 (a negative photoresist; MicroChem Corporation, Newton, Mass.) along the edges on both the front and back sides using a cotton swab. This procedure breaks the continuous coverage of a water layer so that the device will not be electrically shorted when buffer is present on both sides of the chip (44,45). It also permits a quick, greaseless method for sealing the chip surface to the PDMS surfaces of the experimental cell-chip chamber. The chips may be re-used if they are cleaned with the acid bath and the SU-8-5 is reapplied on the edges.

Protein-Vesicle Isolation for Large Pore Devices MaxiK channel C-Less (hSlo) mutant R207Q-N200C was expressed in Xenopus laevis oocytes. Oocytes were injected with 50 nl of 0.2 mg/ml mRNA in water (Tseng-Crank, 1994; Aldeman, 1992). They were maintained at 18° C. in SOS+ gentamycin for about 5 days until homogenization. The preparation of the vesicles was identical to that of Perez et al. (Perez, 1994; Garcia., 1999) and a brief description of the procedure will now be provided. Batches of 20 to 30 oocytes were first rinsed with a 10% w/v sucrose solution dissolved in K-Buffer (600 mM KCl, 5 mM K-PIPES, pH=6.8). Then the oocytes are placed in a 1-ml pyrex tissue grinder from Kontes Duall Glass (Hayward, Calif.) and 10 ml/oocyte of 10% w/v sucrose dissolved in K-Buffer supplemented with protease inhibitors (100 uM phenylmethylsulfonylfluoride, 1 uM pepstatin, 1 ug/ml aprotinin, 1 ug/ml leupeptin, and 1 uM p-aminobenzamidine) from Sigma (St. Louis, Mo.) are also added. The oocytes were mechanically homogenized with a matching rod also from Kontes Duall Glass. The homogenate is placed on top of 20% w/v sucrose: 50% w/v sucrose (both dissolved in K-Buffer with protease inhibitors) gradient in a Sorvall centrifuge tube from Fisher Scientific(Tustin, Calif.). The tube is placed in a swinging bucket holder, which is then mounted on the rotor Sorvall RP55S. The first centrifugation is done at 30,000 RPM (61000×g average) for 30 min at 4° C. with a swinging bucket rotor. The band at the 20:50 interface after the first centrifugation is extracted with syringe with a 20.5 gauge needle. Excess material should be removed from the band because it can lead to unstable bilayers that rupture during incorporation. The extract is diluted 3× with solution A (300 mM sucrose, 100 mM KCl, 5 mM K-MOPS, pH=6.8) and the first centrifugation sequence is repeated. The vesicle preparation should be carried out between 0° C. and 4° C. to minimize protease activity. The pellet precipitate recovered after this step is aliquoted into 4 ml portions in eppendorf tubes. These are then submerged in liquid N₂ and stored in a −80° C. freezer. Prior to use the vesicle preparation is ultrasonicated for 5-15 seconds to increase the proportion of unilamellar vesicles.

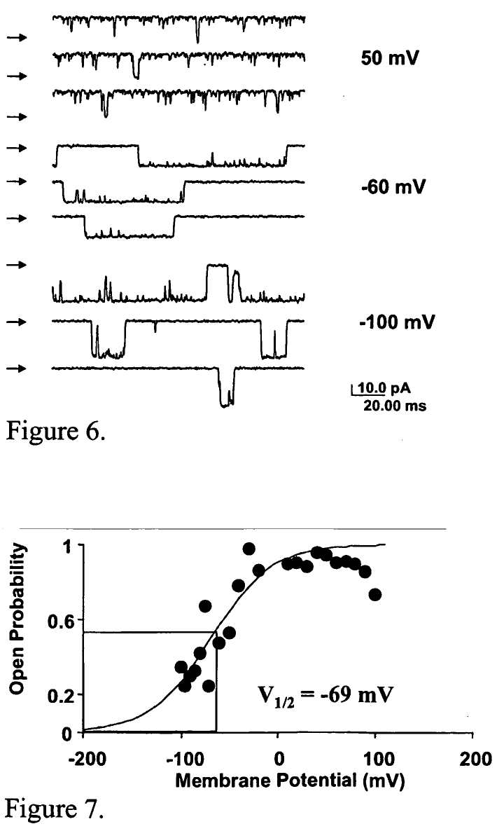

Reconstitution into lipid bilayers in Large Pore Devices The sample chamber used in these experiments was designed as a cylinder threaded within a larger cylinder, with the silicon chip placed horizontally and sealed with Vaseline® at the base of the inside cylinder wafer interface. The inside cylinder, or top compartment (cis side (44)) is held at virtual ground and the bottom compartment (trans side (45)) is the voltage-controlled side. A lipid mixture is prepared by dissolving a phosphatidylethanolamine:phosphatidylcholine:phosphatidylserine (PE:PC:PS) from Avanti Polar Lipids (Alabaster, Ala.) ratio of 5:3:2 in 25 mg/ml in 40 μl of n-decane (Labarca et al., 1992; Laurido et al., 1991; Toro, 1990; Toro et al., 1991). The bilayer and then the vesicles are painted onto the cis side (44) of the wafer using a glass rod. To promote vesicle adhesion the following conditions are established across the partition before the bilayer was painted: 250 mM KCl, 5 mM K-MOPS, 0.1 mM CaCl₂, pH 7.4 solution on the cis side and 50 mM KCl, 5 mM K-MOPS, 0.1 mM CaCl₂, pH 7.4 solution on the trans side. Next, a pulse train is applied of 100 mV for 100 ms followed by −100 mV for 100 ms. Once channel activity starts, (FIG. 6), the conditions may be symmetrized by adding a 3.64M KCl, 5 mM K-MOPS, 0.1 mM CaCl₂, pH 7.4 solution to the trans side (45). Pulsing at a 200 mV with a holding potential (Vₕ) of 0 mV also aided in obtaining channel activity more rapidly.

MaxiK-type Channel Recordings of Large Pore Devices Maxi K recordings of channel Cless R207Q N200C were taken using a 5:3:2 ratio of PE:PC:PS respectively at 25 mg/ml dissolved in n-decane (FIG. 6). Vesicles were applied after the bilayer was formed and had been electrically monitored for several minutes to check stability. It is believed that the vesicles with ion channels come into contact with the bilayer in the following way. There is sufficient lipid-solvent residing in the region near the pore that once the vesicles with the ion channels are painted onto the suspended bilayer, the bilayer surface is broken but a new bilayer simultaneously forms that incorporates the vesicles. Similar to what has been previously reported (Perez et al., 1994, Labarca et al., 1992) ion channel fusion into the bilayer is promoted by a 5:1 [K⁺] concentration gradient with respect to cis:trans.

Large conductance calcium activated potassium ion channel mutant, R207Q has been studied, characterized and reported previously (Toro et al., 1990). The properties of this channel, reconstituted in suspended bilayers on the microchip, agree with what has been previously reported. The polarity of the channels for these experiments always demonstrated that the outside of the channel faces the cis side (44). The conditions for these recordings were initially asymmetrical and then a higher concentration solution was added to the trans side (45) to make the conditions nearly symmetrical. Current amplitudes were also on the correct order of magnitude for R207Q. V_{1/2}, which is the voltage at which the ion channel is open 50% of the time, was −69.4 mV, which is also in the expected range (FIG. 7).

Cell Culturing for Small Pore Devices CHO and RIN m5F (20) cells were used investigate the cell patching capabilities of the microfabricated silicon chips. The CHO cell line did not have transfected ion channels, and so while those cells could be utilized to demonstrate the formation of giga-seals, they were not useful for recording ion channel currents. K_{ATP} and large conductance calcium activated K_{Ca} ion channels are intrinsically expressed by RIN m5F cells (Ribalet et al., 1988; Eddlestone et al., 1989), while the HEK cells expressed mutant Maxi K_{Ca} ion channels. Giga-seal patches to the RIN m5F cells were obtained (90), and standard electrophysiology measurements on those cells were carried out in order to demonstrate the voltage gating of the K_{ca} channels. The RIN m5F cells also had the advantage that they are optically transparent, and so the pore-cell relationship in those devices could be characterized, even with the cell on top of the pore. For example, see FIG. 1 where the pore 21 can be seen even though the cell 20 is on top of it. The preparation conditions did not induce glucose metabolism in the RIN m5F cells, and so it was not possible to separate the activity of the K_{ATP} channels from that of the K_{Ca} channel proteins.

CHO cells were incubated at 37° C. in HAMS F12 medium and the other two mediums were all purchased from the Invitrogen Corporation (Carlsbad, Calif.). The medium was changed every 3 to 4 days. B cells of the insulin-secreting line RIN m5F were incubated at 37° C. in RPMI1640 medium. The cells were divided once a week by treatment with trypsin-EDTA which also purchased from the Invitrogen Corporation (Carlsbad, Calif.). The medium was changed every 3 to 4 days.

Cell isolation for patching The preparation and experimental procedures for isolating and preparing the cells for the chip-based patch clamp experiments were very similar for both cell lines, and so only the specific case of the RIN m5F cells is discussed here. Cells were prepared for patching by first suctioning off the culture media using an aspirator. Then, the cells were then washed of the surface with 10 mL of Dulbecco's Phosphate-Buffered Saline (in g/L: 0.10 anhydrous CaCl₂, KCl 0.20, KH₂PO₄ 0.20, MgCl₂ 8H₂O 0.10, NaCl 8.00 and Na₂HPO₄-7H₂O 2.16) without Ca⁺² or Mg⁺² and transferred to a centrifuge tube. The tube was spun down at 1000 RPM for 5 minutes, and the D-PBS solution was removed. The cells were re-suspended in 1 mL of Trypsin-EDTA (0.05% Trypsin, 0.53 mM EDTA-4Na) purchased from Invitrogen Corporation (Carlsbad, Calif.). Trypsin is an enzyme that will break up aggregates of cells. After 1-2 minutes of trypsin exposure, 9 ml of RPMI 1640 medium was used to stop the trypsin activity. The cells were spun down once more at 1000 RPM for 5 minutes. The trypsin/medium solution was decanted. Two solutions were prepared, an external and an internal solution. The external solution is an aqueous environment that is designed to emulate the physiological environment external to the cell, and has the effect of stabilizing the cell. The purpose of the internal solution is similar, but is intended to emulate the physiological environment inside the cell. One mL of external solution (composition: 135 mM NaCl, 5 mM KCl, 2.5 mM CaCl₂, 1.1 mM MgCl₂, 10 mM HEPES (N-[2-Hydroxyethyl]piperazine-N′-[2-ethanosulfonic acid]) purchased from Sigma (St. Louis, Mo.); pH adjusted to 7.2 with NaOH) was added to the centrifuge tube, and a pipet is used to agitate the cells and resuspend them in the external solution. The cells were then ready to be deposited onto the wafer. External solution (56) and internal solution (57) (140 mM KCl, 1.1 mM MgCl₂, 10 mM HEPES; pH adjusted to 7.2 with KOH) was then added to the top chamber and bottom chambers of the device, respectively, and 50 μl of cell solution was syringed into the top chamber (42). Optical microscopy was then utilized to monitor the surface of the chip, and the resistance of the pore was electrically monitored (80). Once a surface coverage of 20-30% was achieved, gentle suction was applied from the bottom chamber side. Changes in pore capacitance and resistance (81,82) were correlated with optical images (20,21) to interrogate whether or not a cell had patched to the wafer. The CHO cells were placed in an external solution composed of (mM): 145 N-Methyl-D-Glucamine Methanosulfonic acid (NMG-MES) and NMG was also purchased from Sigma (St. Louis, Mo.), 2 CaCl₂ 10 HEPES, and pH 7.2).

Bilayer suspended on a microfabricated large pore silicon chip The ideal system—a cylindrical pore structure—to produce stable highly resistive (giga-seal) bilayers has been modeled by S. White (White, 1972). Silicon processing capabilities allow the preparation of precise structures on the micron scale. Another unique feature of this microchip is that SiO₂ surface was chemically modified by silanization. The alkyl chains of the silane make the surface hydrophobic; thus, enhancing the attraction between the n-decane and the substrate surface to ensure that a tight seal forms between the annulus solvent and aperture. 200 and 100 μm pore diameters were effective at producing stable horizontal bilayers that proved to be extremely robust even in the presence of modest water level differences that may cause hydrostatic pressure. The range of bilayer capacitance values measured from the 100 and 200 μm diameter pores were similar to the range of literature value of 0.4 μF/cm² to 1 μF/cm² (Labarca et al., 1992). These capacitance values, coupled with optical measurements of the suspended bilayers (10), indicates the presence of the bilayer. Bilayer capacitance was observed to increase with increasing pore size. Optical imaging demonstrated that the bilayer was centered both within the pore, and docked at the midpoint to the top and bottom surfaces of the silicon wafer. The rms noise amplitude was nearly equivalent in both types of partitions, and increases as a function of pore area, from 0.5 pA to 1.9 pA for 100 and 200 μm diameter pores respectively. These values are consistent with a range of reported literature values (Wonderlin et al., 1990). The characteristic access resistance of the pores with no bilayer present was about 50KΩ.

Referring to FIG. 3, FIG. 4, and FIG. 5, a semi-conductor wafer-based device in accordance with the present invention is shown generally at 37. The device 37 includes a silicon wafer 30 which has a cis side 44 and a trans side 45 (large pore devices), or an external side 56 and an internal side 57 (small pore devices). The wafer 30 includes a pore 34 that extends through the wafer 30 from the cis (external) side 44 (56) to the trans (external) side 45 (57). The cis and exterior sides may be viewed as a top or first side. The trans and interior sides may be viewed as a bottom or second side. The pore is cylindrical in shape and will have a diameter of between about 1 micrometer to 200 micrometers. The diameter may be varied depending on the particular application. Any pore size and shape is suitable provided that it is of sufficient size to suspend a lipid bilayer. The pore 34 is preferably micro-machined into the wafer 30. It should be noted that the wafer 30 is shown having a single pore 34. In practice, the wafer 30 will have numerous pores micro-machined therein. The single pore 34 is shown for demonstrative purposes only, with it being understood that the invention covers wafers and devices that have multiple pores.

The silicon wafer 30 is coated with an insulating film 35 such that the walls of the pore 34 are covered with an insulating and chemically modifiable coating. Any suitable insulating material may be used, but materials that lend themselves to chemical treatment are desired. Silicon nitride and silicon dioxide are exemplary insulating materials. The insulating film 35 utilized to demonstrate this invention was silicon dioxide. The surface of the insulating film 35 may be treated to alter the adhesion properties of the film 35. The silicon dioxide film 35 was silanized 36 to increase the adhesion of the lipid bilayer to the rim of the pore 34, or was acid cleaned to increase the adhesion of the cell to the rim of the pore 34.

The lipid bilayer 41 which is to be investigated is suspended across a large pore 34 as shown for a demonstrated system in FIG. 1. The lipid bilayer 41 may be composed of the lipids described in the above examples or any other lipid that is capable of forming bilayers. Likewise, the compound, if any, that is encapsulated within the lipid layer 41 can be any compound which is compatible with the lipid and does not destroy the bilayer 41. The invention, as described above is particularly well suited for measuring the properties of transmembrane proteins that are located between the lipid bilayers 41.

The single cell 53 which is to be investigated is suspended across a small pore 34 as shown for a demonstrated system in FIG.2. The cell 53 may consist from any number of different cell lines, and the diameter of the pore 34 or the surface treatment of the wafer 30 may be customized for particular cell lines. The electrical, optical, and chemical signatures of membrane proteins that are in the cells may be investigated in this way. Other actions and properties characteristic of certain cells, such as phagocytosis, may also be monitored in this way, provided that the action or property lends itself to generating an electrical, optical, or chemical signature.

The silicon wafer 30 is preferably thinned in the region surrounding the pore 34 to produce a collar or chamber 33 that allows optical access to the pore/bilayer at illumination angles that vary from normal incidence (i.e. 90 degrees) up to 45 degrees on either side of normal incidence. A thinned pore 34 also enables fluid exchange from the trans region 45 to the membrane 41, or from the internal region 57 through the pore and to the component of the cell that is patched (cell-attached mode) or to the inside of the cell (whole-cell mode). In addition, a chamber 42 is provided to allow chemical access to the cis (external) side 44 (56) of the membrane (cell). A chamber 43 is also provided to allow chemical access to the trans (internal) side 45 (57) of a patched cell 53.

A wide variety of devices or elements may be used to measure the chemical, electrical and/or optical properties of the bilayer 41 or cell 53. Such elements are well-known and they include, elements for measuring electrical properties of the bilayer as described in the above examples. In addition, photometers, spectrophotometers and other well know optical measuring devices or elements may be used including lamps and image collection devices as were used to obtain the images shown in FIGS. 1 and 2.

Having thus described exemplary embodiments of the present invention, it should be noted by those skilled in the art that the within disclosures are exemplary only and that various other alternatives, adaptations and modifications may be made within the scope of the present invention. Accordingly, the present invention is not limited to the above preferred embodiments and examples, but is only limited by the following claims.

Bibliography

Adelman, J. P., Shen, K., Kavanaugh, M. P., Warren, R. A., Wu, Y., Lagrutta, A., Bond, C. T., and North, R. A. 1992. Calcium-Activated Potassium Channels Expressed from Cloned Complementary DNAs. Neuron 9: 209-216.

Aidley, D. J. & Stanfield, P. R. (1996) Ion Channels Molecules in Action (Camridge University, New York, N.Y.).

Brian, A. A. and H. M. McConnell. 1984. Allogenic stimulation of cytotoxic T cells by supported planar membranes. Proceedings of the National Academy of Sciences. 81:6159-6163

Cremer, P. S. and S. G. Boxer. 1999. Formation and Spreading of Lipid Bilayers On Planar Glass Supports. Journal of Physical Chemistry, 103, 2554-2559.

Eddlestone, G. T., Ribalet, B. & Ciani, S. (1989) Comparative Study of K Channel Behavior in B Cell Lines With Different Secretory Responses to Glucose. J.Membrane Biol., 109, 123-134.

Fertig, N., Meyer, Ch., Blick, R. H., Trautmann, Ch., & Behrends, J. C. (2001) Microstructured glass chip for ion-channel electrophysiology. Physical Review E. 64, 040901(1-4).

Garcia, M. L., Giangiacomo, K. M., Hanner, M., Knaus, H., McManus, O. B., Schmalhofer, W. A., and Kaczorowski, G. J. 1999. Purification and Functional Reconstitution of High-Conductance Calcium-Activated Potassium Channel from Smooth Muscle. In Methods in Enzymology, Vol. 294,P. M. Conn, editor, Academic Press.

Groves, J. T., N. Ulman, and S. G. Boxer. 1997. Micropatterning fluid lipid bilayers on solid supports. Science, 275: 651-653.

Han, X., and L. K. Tamm. 2000. A host-guest system to study structure-function relationships of membrane fusion peptides. Proceedings of the National Academy of Sciences 97: 13097-13102.

Harms, G. S., Sonnleitner, M. Schutz, G. J., Gruber, H. J. and Th. Schmidt. 1999. Single-Molecule Anisotropy Imaging. Biophysical Journal. 77: 2864-2870.

Jaklevic, J. M., Garner, H. R., and Miller, G. A. 1999. Instrumentation for the Genome Project. Annual Reviews of Biomedical Engineering. Eng. 01: 649-678.

Kalb, E., S. Frey and L. K. Tamm. 1992. Formation of supported planar bilayers by fusion of vesicles to supported phospholipids monolayers. Biochimica Biophysica Acta. 1103: 307:316.

Labarca, P., and Latorre, R. 1992. Insertion of Ion Channels into Planar Lipid Bilayers by Vesicle Fusion. In: Methods in Enzymology 207, edited by Bernardo, R. and Iverson, L. E., Academic Press.

Labarca, P., and R. Latorre 1992. Insertion of Ion Channels into Planar Lipid Bilayers by Vesicle Fusion, In Methods in Enzymology 207, R. Bernardo and L. E. Iverson, editors. Academic Press, New York 447-463.

Laurido, C., Candia, S., Wolfe, D., and Latorre, R. 1991. Proton Modulation of a Ca²⁺-activated K⁺ Channel from Rat Skeletal Muscle Incorporated into Planar Bilayers. Journal of General Physiology. 98: 1025-1043.

Loechel, B., 2000. Thick-layer resists for surface micromachining. Journal of Micromechanics and Microengineering. 10: 105-115.

Neher, E. & Sakmann, B. (1976) Single-channel currents recorded from membrane of denervated frog muscle fibers. Nature 260, 799-802.

Pantoja, R., Sigg., D., Blunck, R., Bezanilla, F. & Heath, J. R. (2001) Bilayer Reconstitution of Voltage-Dependent Ion Channels using a Microfabricated Silicon Chip. Biophys. J. 81, 2389-2394.

Perez, G., Lagrutta, A., Aldeman, J. P., and Toro, L. 1994. Reconstitution of Expressed K_{Ca} Channels from Xenopus Oocytes to Lipid Bilayers. Biophysical Journal. 66: 1022-1027.

Ribalet, B., Eddlestone, G. T. & Ciani, S (1988) Metabolic Regulation of the K(ATP) and a Maxi-K(V) Channel in the Insulin-Secreting RINm5F Cell. J. Gen. Physiol. 92, 219-237.

Sackmann, E. 1996. Supported Membranes: Scientific and Practical Applications. Science. 271: 43-48.

Scakmann, B. & Neher, E. (1995) Single-Channel Recordings (Plenum, New York, N.Y.).

Salafsky, J., Groves, J. T., and Boxer, S. G. 1996. Architecture and Function of Membrane Proteins in Planar Supported Bilayers: A Study with Photosynthetic Reaction Centers. Biochemistry. 35: 14773-14781.

Schmidt, C., Mayer, M., & Vogel, H. (2000) A Chip-Based Biosensor for Functional Analysis of Single Ion Channels. Angew. Chem. Int. Ed. 39, 3137-3140.

Tatulian, S. A., Jones, L. R., Reddy, L. G., Stokes, D. L. and Tamm, L. K. 1995. Secondary Structure and Orientation of Phospholamban Reconstituted in Supported Bilayers from Polarized Attenuated Total Reflection FTIR Spectroscopy. Biochemistry. 34: 4448-4456.

Toro, L., Ramos-Franco, J., and Stefani, E. 1990. GTP-dependent Regulation of Myometrial K_{Ca} Channels Incorporated into Lipid Bilayers. J. Gen. Physiol. 96: 373-394.

Toro, L., Vaca, L., and Stefani, E. Calcium-activated potassium channels from coronary smooth muscle reconstituted in lipid bilayers. American Journal of Physiology. 260: H1779-H1789, 1991.

Tseng-Crank, J., Foster, C. D., Krause, J. D., Mertz, R., Godinot, N., DiChiara, T. J., and Reinhart, P. H. 1994. Cloning, Expression, and Distribution of Functionally Distinct Ca²⁺-Activitaed K⁺ Channel Isoforms from Human Brain. Neuron 13: 1315-1330.

Voldman, J., Gray, M. L., and Schmidt, M. A. 1991. Microfabrication in Biology and Medicine. Annual Reviews of BioEngineering. 1: 401-425.

Wagner, M. L. and L. K. Tamm. 2000 Tethered Polymer-Supported Planar Lipid Bilayers for Reconstitution of Integral Membrane Proteins: Silane-Polyethyleneglycol-Lipid as a Cushion and Covalent Linker. Biophysical Journal. 79: 1400-1414.

White, S. H. 1972. Analysis of the torus surrounding planar lipid bilayer membranes. Biophysical Journal. 12: 432-445.

White, S. 1986. The Physical Nature of the Bilayer for Reconstituting Ion Channels. In Ion Channel Reconstitution, C. Miller, editor, Plenum Publishing Corp., New York. 55-65.

Wonderlin, W. F., A. Finkel, and R. J. French. 1990. Optimizing planar lipid bilayer single-channel recordings for high resolution with rapid voltage steps. Biophysical Journal. 58: 289-297.

What is claimed is:

1. A semi-conductor wafer-based device designed for analyzing biological materials, said device comprising:
a silicon wafer comprising a first side and a second side, said silicon wafer further comprising one or more walls that define at least one pore extending through said silicon wafer from said first side to said second side, said pore being of sufficient size to suspend a biological material therein; and
a coating covering said wall to provide an insulating film between said wall and said biological material to be suspended therein, said insulating film having a surface to which said biological material is attached when said biological material is suspended within said pore.

2. A semi-conductor wafer-based device according to claim 1 wherein said pore is of a sufficient size to suspend a lipid bilayer therein.

3. A semi-conductor wafer-based device according to claim 1 wherein said pore is of a sufficient size to suspend a single cell therein.

4. A semi-conductor wafer-based device according to claim 1 wherein the surface of said insulating film is chemically modified to alter the adhesion of said biological material to said insulating film surface.

5. A semi-conductor wafer-based device according to claim 1 wherein said one or more walls defining said pore are machined into said silicon wafer.

6. A semi-conductor wafer-based device according to claim 1 wherein said pore is a substantially circular pore have a diameter in the range of about 1 micrometer to 200 micrometers.

7. A semi-conductor wafer-based device according to claim 1 wherein said coating is made from an insulating material selected from the group consisting of silicon nitride and silicon dioxide.

8. A semi-conductor wafer-based device according to claim 7 wherein the surface of said insulating film is silanized to increase the adhesion of said biological material to said insulating film surface.

9. A semi-conductor wafer-based device according to claim 7 wherein the surface of said insulating film is acid-treated to increase the adhesion of said biological material to said insulating film surface.

10. A semi-conductor wafer-based device according to claim 1 wherein said silicon wafer comprises a plurality of said one or more walls that define a plurality of said pores for suspending a plurality of biological materials.

11. A semi-conductor wafer-based device for analyzing biological material, said device comprising:
a silicon wafer comprising a first side and a second side, said silicon wafer further comprising one or more walls that define at least one pore extending through said silicon wafer from said first side to said second side, said pore being of sufficient size to suspend a biological material therein;
a coating covering said wall to provide an insulating film between said wall and said biological material suspended therein, said insulating film having a surface; and
a biological material that is attached to said insulating film surface and thereby suspended within said pore.

12. A semi-conductor wafer-based device according to claim 11 wherein said biological material is selected from the group consisting of lipid bilayers and cells.

13. A semi-conductor wafer-based device according to claim 11 wherein the surface of said insulating film is chemically modified to alter the adhesion of said biological material to said insulating film surface.

14. A semi-conductor wafer-based device according to claim 11 wherein said one or more walls defining said pore are machined into said silicon wafer.

15. A semi-conductor wafer-based device according to claim 11 wherein said pore is a substantially circular pore have a diameter in the range of about 1 micrometer to 200 micrometers.

16. A semi-conductor wafer-based device according to claim 11 wherein said coating is made from an insulating material selected from the group consisting of silicon nitride and silicon dioxide.

17. A semi-conductor wafer-based device according to claim 11 wherein the surface of said insulating film is silanized to increase the adhesion of said biological material to said insulating film surface.

18. A semi-conductor wafer-based device according to claim 11 wherein said silicon wafer comprises a plurality of said one or more walls that define a plurality of said pores for suspending a plurality of biological materials.

19. A semi-conductor wafer-based device according to claim 12 wherein one or more transmembrane proteins are located in said lipid bilayer or cell.

20. A system for measuring the chemical, electrical and/or optical properties of a biological material, said system comprising:
a silicon wafer comprising a first side and a second side, said silicon wafer further comprising one or more walls that define at least one pore extending through said silicon wafer from said first side to said second side, said pore being of sufficient size to suspend a biological material therein;
a coating covering said wall to provide an insulating film between said wall and said biological material suspended therein, said insulating film having a surface;
a biological material that is attached to said insulating film surface and thereby suspended within said pore,; and
one or more elements for measuring said chemical, electrical and/or optical properties of said biological material.

21. A system for measuring the chemical, electrical and/or optical properties of a biological material according to claim 20 wherein said biological material is selected from the group consisting of lipid bilayers and cells.

22. A system for measuring the chemical, electrical and/or optical properties of a biological material according to claim 20 wherein the surface of said insulating film is chemically modified to alter the adhesion of said biological material to said insulating film surface.

23. A system for measuring the chemical, electrical and/or optical properties of a biological material according to claim 20 wherein said one or more walls defining said pore are machined into said silicon wafer.

24. A system for measuring the chemical, electrical and/or optical properties of a lipid bilayer according to claim 21 wherein said pore is a substantially circular pore have a diameter in the range of about 1 micrometer to 200 micrometers.

25. A system for measuring the chemical, electrical and/or optical properties of cell according to claim 21 wherein said pore is a substantially circular pore have a diameter in the range of about 1 micrometer to 2 micrometers.

26. A system for measuring the chemical, electrical and/or optical properties of a biological material according to claim 20 wherein said coating is made from an insulating material selected from the group consisting of silicon nitride and silicon dioxide.

27. A system for measuring the chemical, electrical and/or optical properties of a biological material according to claim 26 wherein the surface of said insulating film is silanized to increase the adhesion of said lipid bilayer to said insulating film surface.

28. A system for measuring the chemical, electrical and/or optical properties of a biological material according to claim 20 wherein said silicon wafer comprises a plurality of said one or more walls that define a plurality of said pores for suspending a plurality of biological materials.

29. A system for measuring the chemical, electrical and/or optical properties of a biological material according to claim 21 wherein one or more transmembrane proteins are located in said lipid bilayer or cell.

30. A method for measuring the chemical, electrical and/or optical properties of a biological material, said method comprising the steps of:
a) providing a system for measuring the chemical, electrical and/or optical properties of a biological material, said system comprising:
a silicon wafer comprising a first side and a second side, said silicon wafer further comprising one or more walls that define at least one pore extending through said silicon wafer from said first side to said second side, said pore being of sufficient size to suspend a biological material therein;
a coating covering said wall to provide an insulating film between said wall and said biological material suspended therein, said insulating film having a surface;
a biological material that is attached to said insulating film surface and thereby suspended within said pore;
one or more elements for measuring said chemical, electrical and/or optical properties of said biological material; and
b) using said one or more elements to measure a chemical, electrical and/or optical property of said biological material.

31. A method for measuring the chemical, electrical and/or optical properties of a cell according to claim 30 wherein said biological material is selected from the group consisting of lipid bilayers and cells.

32. A method for measuring the chemical, electrical and/or optical properties of a biological material according to claim 30 wherein the surface of said insulating film is chemically modified to alter the adhesion of said biological material to said insulating film surface.

33. A method for measuring the chemical, electrical and/or optical properties of a biological material according to claim 30 wherein said one or more walls defining said pore are machined into said silicon wafer.

34. A method for measuring the chemical, electrical and/or optical properties of a lipid bilayer according to claim 31 wherein said pore is a substantially circular pore have a diameter in the range of about 1 micrometer to 200 micrometers.

35. A method for measuring the chemical, electrical and/or optical properties of a cell according to claim 31 wherein said pore is a substantially circular pore have a diameter in the range of about 1 micrometer to 2 micrometers.

36. A method for measuring the chemical, electrical and/or optical properties of a biological material according to claim 30 wherein said coating is made from an insulating material selected from the group consisting of silicon nitride and silicon dioxide.

37. A method for measuring the chemical, electrical and/or optical properties of a biological material according to claim 36 wherein the surface of said insulating film is silanized to increase the adhesion of said biological material to said insulating film surface.

38. A method for measuring the chemical, electrical and/or optical properties of a biological material according to claim 30 wherein said silicon wafer comprises a plurality of said one or more walls that define a plurality of said pores for suspending a plurality of biological materials.

39. A method for measuring the chemical, electrical and/or optical properties of a biological material according to claim 31 wherein one or more transmembrane proteins are located in said lipid bilayer or cell.
